(19) United States
(12) Patent Application Publication
(10) Pub. No.: US 2025/0043452 A1
(43) Pub. Date: Feb. 6, 2025

(54) SYSTEMS AND METHODS FOR HIGH DENSITY ELECTROCHEMICAL ADDITIVE MANUFACTURING WITH CMOS MICROANODE ARRAY

(71) Applicant: Lawrence Livermore National Security, LLC, Livermore, CA (US)

(72) Inventors: Abraham AKININ, Union City, CA (US); Anna Nikolaevna IVANOVSKAYA, Mountain View, CA (US); Razi-Ul Muhammad HAQUE, Alameda, CA (US)

(21) Appl. No.: 18/362,444

(22) Filed: Jul. 31, 2023

(51) Int. Cl. C25D 1/00; B22F 10/30; B22F 10/85; B22F 12/50; B22F 12/90; B29C 64/106; B29C 64/209; B29C 64/386; B29C 64/393; B33Y 10/00; B33Y 30/00; B33Y 50/00; B33Y 50/02

(52) U.S. Cl. CPC C25D 1/003; B22F 10/30; B22F 10/85; B22F 12/50; B22F 12/90; B29C 64/106; B29C 64/209; B29C 64/386; B29C 64/393; B33Y 10/00; B33Y 30/00; B33Y 50/00; B33Y 50/02

(57) ABSTRACT

The present disclosure relates to an additive manufacturing system for forming a part. In one embodiment the system may make use of a controller for generating 2D pattern data for printing a part. A cathode may be used which is adapted to be disposed in a solution contained within a reservoir. The cathode is configured for facilitating electrodeposition to form a part thereon. A printhead is provided which has a plurality of microanodes forming a microanode array, and which is in communication with the controller. The printhead is disposed adjacent to the cathode and configured to receive and use the 2D pattern data to generate current signals applied to the microanodes. The microanodes cause electrodeposition of metal, using the solution, on the cathode at a plurality of select locations on the cathode, and in parallel.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to additive manufacturing systems and methods which make use of a CMOS microanode array for carrying out the formation of a part.

### BACKGROUND

The statements in this section merely provide background information related to the present disclosure and may not constitute prior art.

Localized electrochemical deposition (LECD) is a relatively recent additive manufacturing (AM) technique which can be used to fabricate 3D microcomponents. It operates by combining electrochemical deposition, or electroplating, with fine scanning control of a stimulating anode. A microscale anode in close proximity to a cathode surface will plate dissolved ions into a small voxel. The probe then moves and continues to deposit material creating wires, rods, or other shapes. Unlike conventional microfabrication methods, LECD is much less expensive as it does not need cleanroom facilities, advanced etching or deposition tools, or custom lithography masks. Additionally, LECD can produce features with large aspect ratios that would be impossible with thin film technology. Compared to other metal AM techniques, systems and methods making use of LECD can operate at low temperature. FIG. 1 compares the advantages of LECD to other fabrication strategies. There are currently two main limitations to this technology: speed and accuracy.

Current demonstrations of LECD technology result in a maskless linear scanning process, one voxel at a time. The deposition rate is limited by the chemical reaction kinetics. Secondly, resolution of the printed features is limited by the mechanical micromanipulation/scanning of the anode tip and by the spreading of the ionic currents in the conductive electrolyte. Despite these significant challenges, there has been recent progress and developments by others which have led to advanced techniques to reduce voxel sizes, fabricate difficult shapes, deposit multiple different materials, and simulated optimization of the fabrication parameters.

### SUMMARY

This section provides a general summary of the disclosure, and is not a comprehensive disclosure of its full scope or all of its features.

In one aspect the present disclosure relates an additive manufacturing system for forming a part. The system may comprise a controller for generating 2D pattern data for printing a part. A cathode may be included which is adapted to be disposed in a solution contained within a reservoir. The cathode may be configured for facilitating electrodeposition to form a part thereon. A printhead may be included which has a plurality of microanodes forming a microanode array, and being in communication with the controller. The printhead may be disposed adjacent to the cathode and configured to receive and use the 2D pattern data to generate current signals applied to the microanodes. This enables the microanodes to cause electrodeposition of conductive material, using the solution, on the cathode at a plurality of select locations on the cathode, in parallel.

In another aspect the present disclosure relates to an additive manufacturing system for forming a part. The system may comprise a controller for generating digital 2D pattern data for printing a part. A cathode may be included which is adapted to be disposed in a solution for facilitating electrodeposition, on which the part is to be formed. The system may also include a printhead having a plurality of microanodes forming a microanode array grid, and being in communication with the controller. A motion control subsystem may be included which is configured to control motion of the printhead within at least an X axis and Y axis plane. The printhead may be disposed adjacent to the cathode and configured to receive and use the 2D pattern data to generate current signals applied to the microanodes. This enables the microanodes to cause electrodeposition of metal, using the solution, on the cathode at a plurality of select locations on a first region of the cathode, in parallel. The motion control subsystem may be further configured to move the printhead over a second region of the cathode not coincident with the first region, to enable the printhead to be used to create electrodeposition of metal at select locations within the second region of the cathode, using the solution and additional 2D pattern data.

In another aspect the present disclosure relates to a method for additively manufacturing a part. The method may comprise disposing a cathode in a solution for facilitating electrodeposition, on which the part is to be formed. The method may also include supporting a printhead over the cathode at a predetermined distance from the cathode, the printhead having a plurality of spaced apart microanodes forming a microanode array. The method may further include electrically energizing selected ones of the plurality of spaced apart microanodes, simultaneously and in parallel, using 2D pattern data. The method may further include using the selected ones of the plurality of spaced apart microanodes to cause simultaneous, parallel electrodeposition of metal at a plurality of locations on the cathode corresponding to the selected ones of the spaced apart microanodes, using the solution, as the printhead is moved along at least one of an X axis, a Y axis or a Z axis.

In still aspect the present disclosure relates to a printhead for use in an additive manufacturing (AM) electrodeposition system, wherein the AM electrodeposition system includes a cathode submerged in a plating solution having conductive ions. The printhead may comprise a substrate forming a printed circuit board, and a microanode array formed as part of an application specific integrated circuit on the substrate. The microanode array may include a plurality of spaced apart microanode control circuits arranged in a grid-like arrangement. An electrical component may be included feeding 2D pattern data to the microanode array to selectively energize ones of the plurality of microanodes circuits, simultaneously and in parallel, to cause simultaneous electrodeposition of conductive material on the cathode at a plurality of locations corresponding to the energized ones of the plurality of microanode circuits.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a chart showing the drawbacks and/or limitations of various prior art additive manufacturing methods with respect to the present disclosure;

FIG. 2 is a high level block diagram of one example of a system in accordance with the present disclosure;

FIG. 3 is a more detailed side view of one embodiment of just the printhead of the system shown in FIG. 2;

FIG. 3a is a high level block diagram of another example of the print head of FIG. 2 showing the print head implemented using 3D packaging technology; and

FIG. 4 is a high level flowchart of various operations that may be performed in manufacturing a part in accordance with one example of a method of the present disclosure.

### DETAILED DESCRIPTION

Example embodiments will now be described more fully with reference to the accompanying drawings.

The present disclosure is directed towards systems and methods which further significantly expand and improve the capabilities of a LECD system in printing high aspect features using various materials such as metals, metal composites, or conductive polymers. The present systems and methods present solutions to the main limitations of LECD by implementing High Density LECD (HD-LECD) through a scalable LECD print head created with CMOS technology (i.e., through a commercial integrated circuit process). The application specific integrated circuit (ASIC) chip inside the print head in one embodiment to be described herein is a microanode array with hundreds to thousands or more of parallel electrodes and independent current generator circuits. This massive parallelization increases the electrodeposition throughput by, as well as improves the accuracy of, the deposition geometry through targeted control of the electric fields in the electrolyte. It is expected that the various embodiments and methods described herein will find significant interest and utility in a wide variety of technical fields and disciplines including, but not limited to, applications involving the manufacture of parts and components for use in in energy storage applications, biomedical applications, electrical interconnect applications, and on-chip sensor applications.

Referring to FIG. 2 there is shown one embodiment of a system 10 in accordance with the present disclosure. The system 10 in this example includes a printhead 12 supported closely adjacent a cathode 14. The cathode in this particular example is shown as being planar, but other non-planar shapes (e.g., slightly curved or otherwise custom) are possible as well. The cathode 14 is disposed within an electrolyte solution 16 having ions 16a contained in a reservoir 18. The cathode 14 may be formed from a suitable electrically conductive material, and in one embodiment is formed from copper.

The printhead 12 may be moved in a highly controlled manner within an X/Y plane, and also along a Z axis, via a motion control subsystem 20. In one embodiment the motion control subsystem 20 may include a plurality of DC stepper motors 22, for example one for each of the X, Y and Z axes, that enable independent motion of the printhead along all three of the X, Y and Z axes via a 3D stage 21. The motion control subsystem may instead include a plurality of piezoelectric motors for producing highly controlled movement of the printhead 12 along each of the X, Y and Z axes. Still further, optionally, the use of one or more DC stepper motors and one or more piezoelectric motors may be used together as well to form the motion control subsystem 20. In some embodiments, a further variation may be the of one or more linear actuators to help position the printhead 12 within the X/Y plane and/or within the Z plane, and in some embodiments a combination of DC stepper motors, piezoelectric motors and linear actuators may be used. A suitable beam-like support structure 21a may be operably coupled to the 3D stage 21 and used to support the printhead 12 for movement by the motion control subsystem 20 in the X, Y and Z axes.

It will also be appreciated that the motion control subsystem 20 may instead be operably coupled to the reservoir 18 for controllably moving the reservoir or the cathode 14 within the X, Y and Z planes, while the printhead 12 is maintained stationary. Still further, it is contemplated in some embodiments, both the printhead 12 and the reservoir 18 may be moved, for example one or the other of the printhead 12 or reservoir 18 being moved along the X and Y axes, and the other being moved along only the Z axis. All of the above described embodiments are contemplated by the present disclosure.

The motion control subsystem 20 may be controlled by control and/or drive signals provided by an electronic position controller 22 via signal lines 24a, 24b, 24c. Signal lines 24a, 24b and 24c may be separately dedicated to providing control and/or drive signals for driving the printhead 12 along the X, Y and Z axes. A computer, electronic controller or microcontroller 26 (hereinafter simply “controller” 26) may be used to provide control signals via a bus 28 to the position controller 22, as well as control signals in the form of 2D pattern digital data via a bus 30 to electrical/electronic components on the printhead 12, and/or to receive feedback signals from the position controller 22 and/or the printhead 12. In some embodiments the controller 26 may include a memory 27 (e.g., RAM, ROM, non-volatile RAM, non-volatile ROM, etc.) for storing algorithms and/or data files 27a and/or one or more look-up tables 27b. In some embodiments a closed loop system may be formed between the controller 26 and the position controller 22 for controlling movement of the printhead 12, and in some embodiments an open loop system may be implemented using the controller 26 and the position controller 22 for controlling printhead 12 movement. In some embodiments feedback signals may also be received by the controller 26 from the printhead 12 via bus 30 or via a different communication bus/line (not shown) for monitoring printhead performance in real time and modifying printhead operation in real time.

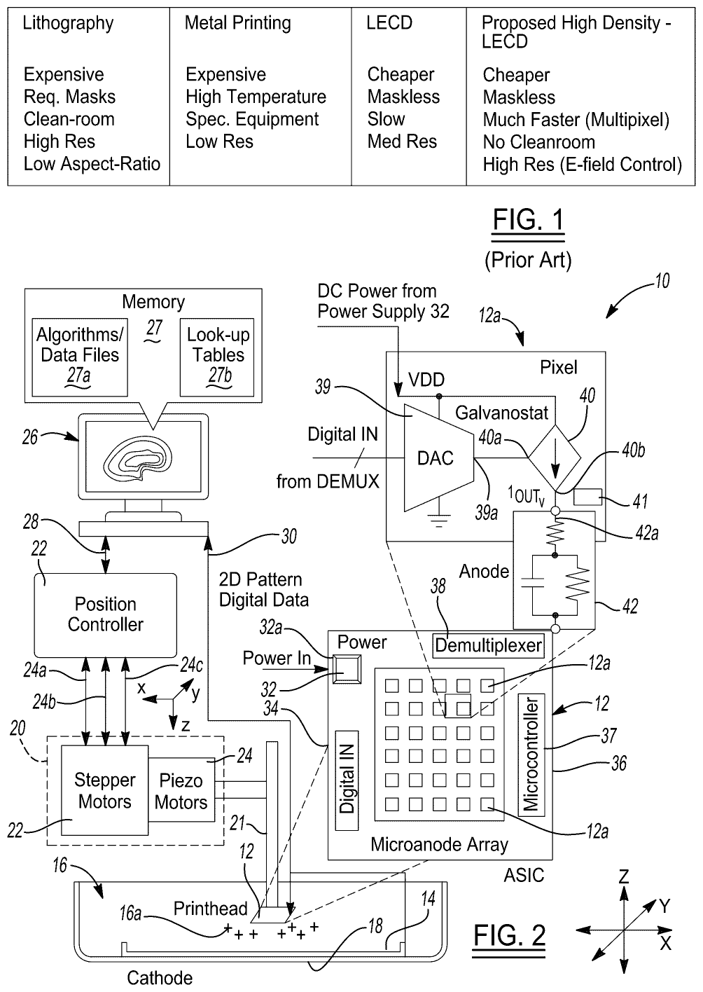

FIG. 1 also shows a highly enlarged plan view of the printhead 12. In one embodiment the printhead 12 is a CMOS application specific integrated circuit (“ASIC”) which forms a microanode array (an array of microanode pixels). The printhead 12 can be seen to include an input port 32a of a power supply 32 for receiving power (typically DC) from an external DC power source. The power supply 32 provides a regulated DC voltage (e.g., “Vdd”) to the various components on of the printhead 12. A “Digital In” input port 34 receives the 2D pattern digital data from the computer 26. Such data may also include electrodeposition variables such as current pulse amplitude and duration for each microanode pixel. The microanode array in this example is formed by an X/Y grid-like arrangement of spaced apart microanodes 12a formed on a substrate 36. Each of the microanodes 12a may also be in communication with a demultiplexer 38, which in turn is in communication with the Digital In input port 34 via a suitable bus (not visible in FIG. 2). The substrate 36 may also support a microcontroller 37 which is in communication with the demultiplexer 38. The microanodes 12a may be independently activated to output current via signals received from the demultiplexer 38. As such, selected ones of the microanodes 12a may be simultaneously activated at arbitrary current amplitudes, in parallel, to cause selected electrodeposition of metal, simultaneously at precisely defined locations within a given region of the cathode 14, or possibly over an entire area of the cathode 14 all at once.

The microanodes 12a may be understood as each forming an independently controlled pixel. The microanodes 12a are each shown in this example as square shaped, and it is expected that this may be the desirable shape, at least from a manufacturing standpoint. However, the microanodes 12a may possibly be formed in other shapes (e.g., round, rectangular, triangular, etc.) as well. Similar, while the microanodes 12a are shown in an X/Y axis square-grid-like (i.e., uniform rows and columns) configuration, this is but one example of a suitable arrangement, and other arrangements are contemplated and within the scope of the present disclosure as well. Such other arrangements may involve, for example and without limitation, a triangular or hexagonal grid, concentric rings of microanodes 12a, or even combinations of different shaped microanodes arranged in a combination of an X/Y grid and some other configuration (e.g., concentric rings). Regardless of the configuration of the microanodes 12a, the printhead 12 is preferably positioned closely adjacent the cathode 14, and in some implementations within about 1 μm-1000 μm depending on the size of the anodes, and in some implementations possible below or above this range. Those skilled in this art will appreciate, however, that the precise gap to be used in a specific application will likely vary according to other factors, such as for example, and without limitation, the conductivity of the electrolyte solution 16, the geometry of the microanodes 12a, the desired or required precision in the Z dimension, as well as other parameters.

With the generally square shaped microanodes 12a shown in FIG. 1, each microanode may range significantly in its length and width dimensions, but in one example the length and/or width of each may be between about 10 μm-50 μm, and in another example may in some implementations be between about 10 μm-1 mm. In some embodiments adjacent ones of the microanodes 12a are separated by a distance (i.e., “pitch”) of between about 10 μm-100 μm on each side thereof. These are but a few examples of suitable dimensions, and it will be appreciated that the dimensions may vary to suit the needs of a specific application and possibly the needs of a particular part being made with the system 10. In some embodiments it is anticipated that dozens, hundreds, or possibly thousands or more microanodes 12a may be used to help form the printhead 12. Still further, multiple ASICs may be tiled or combined in parallel to form a larger array of microanodes. The optimum number, dimension, and pitch of microanodes 12a needed may thus vary considerably depending on the size of the part being formed and other factors.

FIG. 2 similarly shows a breakout of one microanode 12a, which may be thought of as one independently controllable pixel, and which is formed by an independently controllable galvanostatic circuit. In this example the microanode 12a may include a DAC (Digital-to-Analog Converter) 39 which receives 2D pattern digital data signals from the demultiplexer 38. The microcontroller 37 may be used to control the demultiplexer 38 and possibly other components on the print head 12. An output 39a of the DAC 39 provides an analog signal in relation to the received digital signal to an input 40a of a current amplifier 40. The current amplifier 40 provides a controlled current output signal at an output 40b in accordance with the analog signal from the DAC 38 to an input 42a of a microanode element 42. As the print head 12 controls the current output through each of the microanodes 12a, a voltage sensor 41 (or voltage acquisition or monitoring circuit) measures the output voltage associated with each microanode 12a. The microanode element 42 is positioned closely adjacent the cathode 14 and, in some embodiments between about 1 μm-25 μm, and in some embodiments within about 5 μm from the cathode 14. The microanode element 42, when energized by output current, causes an electrodeposition of ions 16a in the solution into a small voxel on the cathode 14. By “small”, this means a voxel that may vary significantly in volume. In some embodiments the voxel may be within a volume defined by the microanode element 42 (i.e., (electrode tip size) 3/K, where “K”=0.5, 10), but may be thinner in the Z dimension depending on the current amplitude, duration and conductivity of the electrolyte solution 16, and possibly other factors. Accordingly, those skilled in the art will appreciate that the volume of the voxel may vary significantly according to a wide variety of factors. Thus, selectively energizing various ones of the microanodes 12a of the print head 12 as the print head is scanned over the cathode 14 enables material to be deposited in rapidly in a highly efficient manner to create parts of various sizes and shapes. Thus, for example, wires, rods, beams or a wide variety of other parts having widely varying, intricate cross-sectional 3D shapes can be created, and in some applications in a layer-by-layer fashion, and on an extremely small scale, if needed. Alternatively, multiple smaller parts can be created in parallel. Optionally, the electrolyte bath 16 could be switched out (e.g., one or more times) during the part forming process to enable plating different materials as one or more different layers (e.g., in one example gold on a flexible conductive polymer).

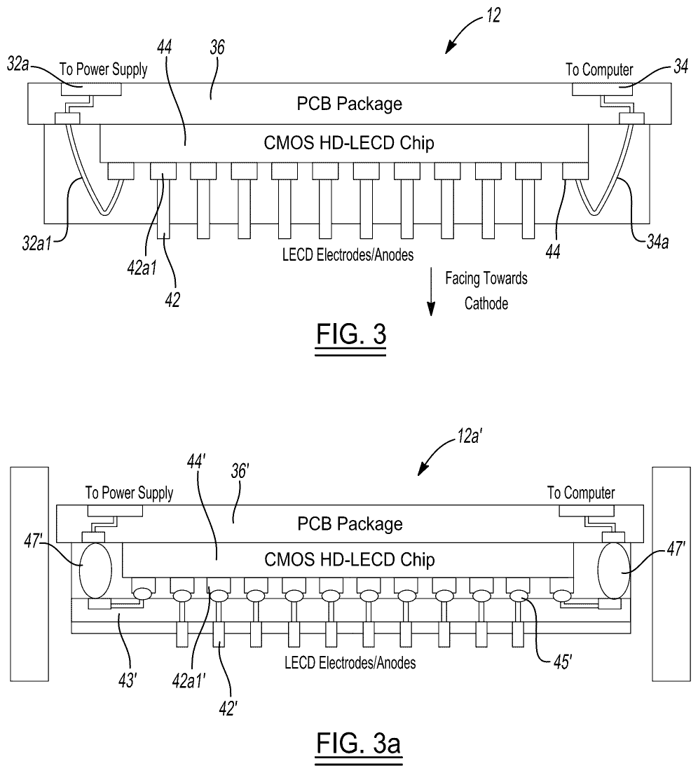

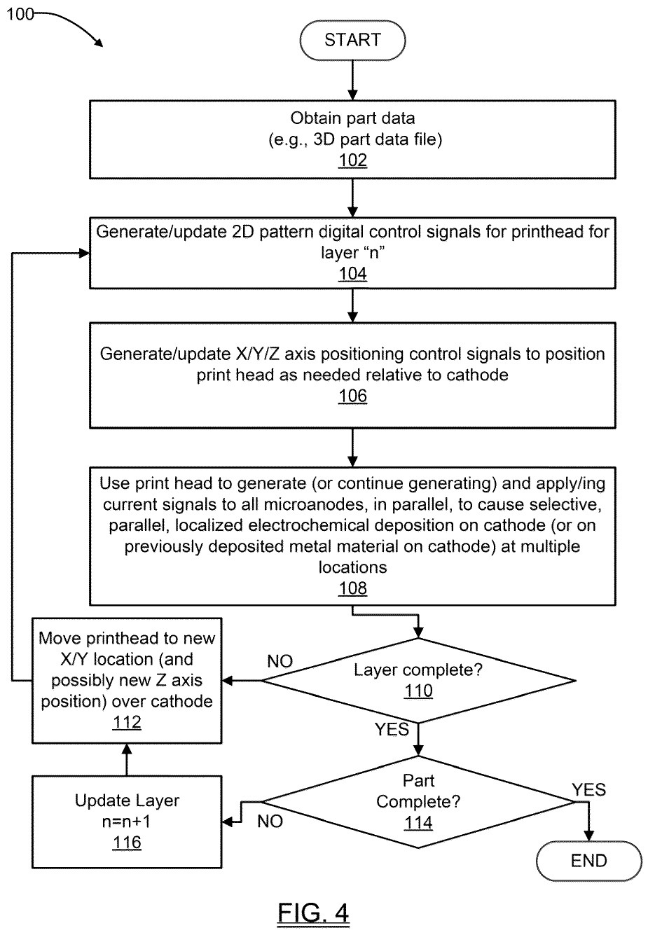

Referring now to FIG. 3, a more detailed illustration of one example of the construction for the print head 12 is shown in a cross-sectional side view. With the printhead 12 in this example, the substrate 36 forms a printed circuit board (PCB, hereinafter “PCB 36”), although other substrates and fabrication processes can be used to manufacture the package and connector layer of the printhead. Attached to the PCB 36 is a CMOS, high density (HD) LECD chip 44. The PCB 36 may also contain a wide variety of auxiliary active or passive electrical components (not shown) to support the function of the LECD chip 44, such as, without limitation, decoupling capacitors. Power is applied to the PCB 36 and the LECD chip 44 via the power supply 32 at input port 32a. A bond wire 32a1 supplies power to the LECD chip 44. The 2D pattern digital data used by the LECD chip 44 is received from the controller 26 at port 34 and supplied to the LECD chip 44 by a bondwire 34a. Serial 2D digital pattern data thus comes into the LECD chip at input port 44a and is used by the LECD chip and is converted by the LECD chip into a plurality of independent current signals that are selectively applied, in parallel, to the plurality of independent microanode elements 42 via IC contact pads 42a1, to electrically energize selected ones (or possibly even all) of the independent microanode elements 42. Each microanode element 42 may be constructed from a suitable metal, for example in some embodiments and without limitation, from titanium, platinum or gold. In some embodiments the microanode elements 42 may each be formed with a column-like or cylindrical (e.g., round, square, etc.) shape. When energized with electrical current, each microanode element 42 causes an electrochemical deposition to occur on the cathode 14 within a limited area defined by the proximity of each microanode element 42 to the cathode surface. In this manner, controllably outputting current through the microanode elements 42 enables high resolution beams, rods, wires, and a wide variety of other shapes, to be formed while creating a 3D part.

In some embodiments of the print head 12, its design may be based on a standard mixed signal CMOS process, and in other embodiments a high-voltage capable process may be used in the design. Still further, in some embodiments the print head design 12 may be based on the Taiwan Semiconductor Corporation (TSMC) 180 nm process node, as this enables an affordable print head design. In some embodiments the array of microanodes 12a may be selected to form a predetermined minimum number of pixels, for example a minimum of 625 parallel pixels (a 25×25 grid) with a predetermined maximum pitch (i.e., separation) between pixels. In some embodiments the maximum pitch may be about 40 μm. It will be appreciated, however, that the microanode array can be scaled to larger or smaller numbers, and the specific pitch selected may be modified to be great or less than 40 μm. Still further, for example, a user could make use of multiple printheads with different resolution depending on the application, the maximum dimensions of the part to be produced, and possibly other factors as well. As each microanode 12a (i.e., pixel) contains all the required circuits, the ASIC HD-LECD chip 44 is able to be connected directly to a computer or microcomputer (e.g., controller 26) therefore controlling very large scale multipixel electrodeposition in a scalable manner through a small number of wires, or even a single cable without the need for bulky potentiostat instruments.

In some embodiments the ASIC HD-LECD chip 44 may be die-attached to the PCB substrate 36. In some embodiments the peripheral pads of the HD-LECD chip 44, which serve to connect power and digital data to the chip, may be wirebonded onto the PCB substrate 36. In some embodiments to ensure reliability the PCB substrate 36 may have an electroless nickel electroless palladium immersion gold (“ENEPIG”) surface finish. Following this assembly step, electrodes may be electrodeposited to extend the electrode reach beyond the wirebond loop, after which the all the components of the HD-LECD chip 44 will be encapsulated with a level surface. Alternatively, the printhead 12 and corresponding ASIC can be assembled with 3D integrated circuit packaging technology: the IC can be die attached to the PCB package, another PCB, or flex PCB can be flip chip bonded to the IC to serve both as a contact layer for the electrodes 42 to 42a1, and as a routing layer for peripheral pads. The system shall preferably be encapsulated to prevent damage to the IC and exposure of electrical contacts to the plating solution.

Referring briefly to FIG. 3a, a high level block diagram is shown of another example of the printhead 12′. The printhead 12′ in this example is implemented using 3D packaging technology, and elements in common with the printhead 12 have been denoted with a prime (′) symbol. This embodiment also makes use of a flex PCB interposer to assist in routing power and serial data through the device. Electrically conductive ball contacts 45′ help to make electrical connections between the microanode elements 42′ and the IC contact pads 42a1′, while electrically conductive ball contacts 47′ help to make electrical connections the Power Supply connection and to an external computer.

Referring now to FIG. 4, a flowchart 100 is shown illustrating various operations that may be performed in accordance with a method of the present disclosure when manufacturing a 3D structure in a layer-by-layer approach. It will be appreciated, however, that many 3D parts, in particular beam-like or columnar parts, may be formed in a generally continuous approach simply gradually moving the printhead 12 along the X, Y and Z axes as needed while select ones of the microanode elements 42 are being energized and de-energized, to thus cause a somewhat continuous electrodeposition to occur as a part is being built. As such, the system 10 does not necessarily need to carry out a traditional layer-by-layer AM approach to form a 3D part.

The operations shown in FIG. 4 may also be performed by one or more embodiments of the system 10, and in some implementations not all of the operations may be needed. Accordingly, the flowchart 100 should be understood as being just one example of operations may be performed to carry out a method in accordance with the present disclosure.

In FIG. 4, at operation 102, 3D part data may be obtained for a structure or part being constructed. At operation 104 digital control signals may be generated to create the 2D digital pattern data needed to construct the structure or part. At operation 106 the X, Y and Z axis control signals may be generated by the controller 26 to control movement of the printhead 12 as needed and to position the printhead 12 at a desired distance from the cathode 14 (or the previously material layer formed on the cathode). In some instances, depending on the overall dimensions of the printhead 12, the number of microanodes 12a being used and the dimensions of the structure or part being constructed, no movement of the printhead 12 may be needed, and thus operation 106 should be viewed as an optional operation.

At operation 108 the printhead uses the 2D pattern digital data to generate (or continue generating) and apply/ing current signals to all microanodes 12a, in parallel, to cause selective parallel, localized electrochemical deposition on the cathode 12 (or on a previously formed metal layer portion) at multiple locations. At operation 110 a check may be made (e.g., by the controller 26) to determine if the layer of the structure or part being formed is complete. If this check produces a “NO” answer, then the printhead 12 may be moved to be positioned over a new region of the cathode 14, as indicated at operation 112, which is non-coincident with the region where the previous printing just occurred. This assumes that the overall X/Y coverage area of the printhead 12 is insufficiently large to print a single layer without lateral movement of the printhead. In this example, then, it will be appreciated that lateral movement of the printhead 12 is needed to completely form a single layer of the part. Accordingly, operation 112 may include using the motion control subsystem 20 and the position controller 22 to obtain the X and Y axis coordinates to which the printhead 12 needs to be moved to, and so moving the printhead to the new region for a subsequent printing operation at the new region on the cathode (or on a prior material layer deposited on the cathode).

If the check at operation 110 produces a “YES” answer indicating that the layer is complete, then at operation 114 another check is made (e.g., by the controller 26) if printing of the structure or part is now complete. If this check produces a “NO” answer, then the layer is updated to the next subsequent layer (i.e., n=n+1) at operation 116, the printhead 12 is moved to a new X/Y region over the cathode 14 and repositioned at a different Z axis elevation in accordance with the next layer to be printed, all for example using the motion control subsystem operation 20 and the position controller 22. Operations 104-112 may then be repeated to generate the 2D pattern digital data for the new layer. Operations 106-110 are then repeated to print the new region on the subsequent layer. However, if the check at operation 112 indicates that the structure or part is now complete, then the process ends.

It will be appreciated as well that post-processing operations (e.g., annealing, peening, subtractive operations such as etching, etc.) may also be performed on the part or structure as well after the operations of flowchart 100 have concluded.

When constructing the system 10, it will be appreciated that in some embodiments of the system 10, following printhead 12 fabrication, the printhead may be attached to the 3D stage 21 ensuring the printhead surface is perpendicular to the beam-like support structure 21a (FIG. 2).

It will also be appreciated that by monitoring the voltage of each of the microanodes 12a relative to the cathode 14 in real time, a determination may be made by the controller 26 as to how close the print head 12 is to the cathode, or by extension to the nearest voxel of electrochemically deposited material. This feature may be used to calibrate the printhead 12 position, increase precision of the electrochemical deposition, or further control the manufacture of a part or specific features of a part in real time as the manufacturing process is being carried out.

In some embodiments the printhead 12 of the system 10 may be used to print structures relevant to microbattery electrodes, miniature antennas, as well as neural prosthetic electrodes, in various metals and other conductive substrates. Formulation of the solution chemistry, primers, and operation parameters used to make such components and parts may all vary to meet the needs of the specific component or part being constructed. In some embodiments optimization of print head 12 performance parameters may be carried out through control of current amplitudes, current pulse duration, solution chemistry, working distance between the print head and the cathode 14, and grouped microanode 12a size, one or more of which may be modified to vary the deposition rate and the fundamental 3D resolution of the printed structure or part. These are but some of the parameters that may be modified to optimize printing using the system 10, and those skilled in the art will appreciate that within the general space of AM, there are many other aspects that may be optimized as well. Some other aspects that may be optimized may involve alternate printhead/plotting paths, segmentation, enhancement of the part geometry through simulation and software algorithms, etc.

The system 10 thus provides a feasible path to industrial scale manufacturing of a wide variety of parts, components or structures including, but not limited to, microbatteries, miniature antennas, medical electrode arrays, microneedles, and sensors, just to name a few. One specific application may be performing HD-LECD AM directly on top of other ASICs to create on-chip antennas, on-chip batteries, on-chip MEMS sensors, wirebonds, and other subsystems or components as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An additive manufacturing system for forming a part, the system comprising:
a controller for generating 2D pattern data for printing a part;
a cathode adapted to be disposed in a solution contained within a reservoir, the cathode configured for facilitating electrodeposition to form a part thereon;
a printhead having a plurality of microanodes forming a microanode array, and being in communication with the controller; and
the printhead being disposed adjacent to the cathode and configured to receive and use the 2D pattern data to generate current signals applied to the microanodes to enable the microanodes to cause electrodeposition of conductive material, using the solution, on the cathode at a plurality of select locations on the cathode, in parallel.

2. The system of claim 1, wherein the plurality of microanodes of the printhead are arranged in an X/Y grid.

3. The system of claim 1, wherein the plurality of microanodes each include a microanode element, and wherein each said microanode element is formed in a square shape.

4. The system of claim 1, wherein each one of the plurality of microanodes is separated from an adjacent one of the microanodes by a pitch of between 1 μm to 1000 μm.

5. The system of claim 1, further comprising a motion control subsystem including at least one of a stepper motor, a piezoelectric motor or a linear actuator, and configured to control movement of at least one of the print head or the reservoir along at least an X axis and a Y axis.

6. The system of claim 5, further comprising a position controller configured to generate position control signals for use by the motion control subsystem.

7. The system of claim 6, wherein the motion control subsystem is further configured to control movement of at least one of the printhead or the reservoir in a Z plane extending perpendicular to a plane formed by the X axis and the Y axis.

8. The system of claim 1, wherein each one of the plurality of microanodes comprises a galvanostat.

9. The system of claim 8, wherein each one of said plurality of microanodes includes a digital-to-analog converter (DAC), a current amplifier in communication with an output of the DAC, a voltage measurement element, and a microanode circuit having an input for receiving an output of the current amplifier.

10. The system of claim 1, wherein the print head comprises a complementary metal oxide silicon (CMOS) application specific integrated circuit.

11. The system of claim 1, wherein the printhead comprises a demultiplexer configured to demultiplex the 2D pattern signals received from the controller, and applying the demultiplexed 2D pattern signals to the plurality of microanodes in parallel.

12. An additive manufacturing system for forming a part, the system comprising:
a controller for generating digital 2D pattern data for printing a part;
a cathode adapted to be disposed in a solution for facilitating electrodeposition, on which the part is to be formed;
a printhead having a plurality of microanodes forming a microanode array grid, and being in communication with the controller;
a motion control subsystem configured to control motion of the printhead within at least an X axis and Y axis plane;
the printhead being disposed adjacent to the cathode and configured to receive and use the 2D pattern data to generate current signals applied to the microanodes to enable the microanodes to cause electrodeposition of metal, using the solution, on the cathode at a plurality of select locations on a first region of the cathode, in parallel; and
the motion control subsystem further configured to move the printhead over a second region of the cathode not coincident with the first region, to enable the printhead to be used to create electrodeposition of metal at select locations within the second region of the cathode, using the solution and additional 2D pattern data.

13. The system of claim 12, wherein the microanodes are separated by a pitch of between 10 μm to 1000 μm.

14. The system of claim 12, wherein the microanodes of the microanode array grid are arranged in an X and Y axis grid-like formation.

15. The system of claim 12, wherein each said microanode comprises:
a digital-to-analog converter (DAC);
a current amplifier in communication with an output of the DAC and configured to generate a current output signal;
an output voltage sensing, measurement or acquisition element; and
a microanode element having an input for receiving the current output signal from the current amplifier.

16. The system of claim 15, wherein the printhead comprises a complementary metal oxide silicon (CMOS) application specific integrated circuit.

17. The system of claim 16, wherein the printhead further includes a demultiplexer configured to demultiplex the digital 2D pattern data received from the controller, and applying the demultiplexed digital 2D pattern data as signals, in parallel, to the plurality of microanodes.

18. The system of claim 12, further comprising a position controller in communication with the electronic controller and the motion control subsystem for generating position control signals to be used by the motion control subsystem.

19. A method for additively manufacturing a part, comprising:
disposing a cathode in a solution for facilitating electrodeposition, on which the part is to be formed;
supporting a printhead over the cathode at a predetermined distance from the cathode, the printhead having a plurality of spaced apart microanodes forming a microanode array;
electrically energizing selected ones of the plurality of spaced apart microanodes, simultaneously and in parallel, using 2D pattern data; and
using the selected ones of the plurality of spaced apart microanodes to cause simultaneous, parallel electrodeposition of metal at a plurality of locations on the cathode corresponding to the selected ones of the spaced apart microanodes, using the solution, as the printhead is moved along at least one of an X axis, a Y axis or a Z axis.

20. A printhead for use in an additive manufacturing (AM) electrodeposition system, wherein the AM electrodeposition system includes a cathode submerged in a plating solution having conductive ions, the printhead comprising:
a substrate forming a printed circuit board;
a microanode array formed as part of an application specific integrated circuit on the substrate; and
the microanode array including a plurality of spaced apart microanode control circuits arranged in a grid-like arrangement; and
an electrical component for feeding 2D pattern data to the microanode array to selectively energize ones of the plurality of microanodes circuits, simultaneously and in parallel, to cause simultaneous electrodeposition of metal material on the cathode at a plurality of locations corresponding to the energized ones of the plurality of microanode circuits.
